(19) United States
(12) Patent Application Publication
(10) Pub. No.: US 2026/0296956 A1
(43) Pub. Date: Oct. 1, 2026

(54) TRANSPARENT SUBSTRATE PROVIDED WITH A FUNCTIONAL STACK OF THIN LAYERS

(71) Applicant: SAINT-GOBAIN GLASS FRANCE, COURBEVOIE (FR)

(72) Inventors: Denis GUIMARD, AUBERVILLIERS (FR); Romain HIVET, AUBERVILLIERS (FR); Anne LELARGE, AUBERVILLIERS (FR); Andrew ROSS, AUBERVILLIERS (FR)

(21) Appl. No.: 19/477,694

(22) PCT Filed: Apr. 23, 2024
(86) PCT No.: PCT/EP2024/061102

§ 371 Date: Oct. 22, 2025

(30) Foreign Application Priority Data
Apr. 24, 2023 (FR) FR2304098

(51) Int. Cl. C03C 17/36

(52) U.S. Cl. CPC C03C 17/366; C03C 17/3626; C03C 17/3644; C03C 17/3649; C03C 2217/212; C03C 2217/216; C03C 2217/219; C03C 2217/256; C03C 2217/26; C03C 2217/281; C03C 2218/156

(57) ABSTRACT

A transparent substrate provided with a functional stack of thin layers on at least one of its faces, the functional stack including, starting from the substrate, at least one metallic functional layer placed between two dielectric modules of thin layers, and wherein at least one of the dielectric modules of thin layers includes a layer of tungsten oxide having a physical thickness between 5 nm and 50 nm, and the tungsten oxide includes at least one doping element selected from the chemical elements of group 1 according to the IUPAC nomenclature or is pure substoichiometric, WOx.

### TECHNICAL FIELD

The invention relates to a transparent glass substrate provided with a functional stack of thin layers with several metallic functional layers.

### TECHNICAL BACKGROUND

Functional stacks of thin layers are commonly used to provide functions of thermal insulation and/or solar protection to glazings. These glazings can equip buildings or vehicles. They aim in particular to reduce the air-conditioning effort and/or to reduce excessive overheating (so-called “solar control” glazings) and/or to reduce the amount of energy dissipated to the outside (so-called “low-emission” glazings).

One type of functional stack of thin layers used in particular comprises a metallic functional layer, in particular based on silver, allowing the reflection of a part of the electromagnetic radiation, in particular infrared radiation.

The metallic functional layer is generally arranged between two dielectric assemblies, also called dielectric modules, in order to neutralize the optical effects of reflection and refraction in the visible range. These dielectric modules may comprise one or more thin dielectric layers of the nitride type, for example silicon or aluminum nitride, and/or of the oxide type, for example silicon, zinc, or tin oxide.

Solar control functions are desired for the glazings capable of being exposed to high sunshine levels. The capacity of a glazing to limit the amount of light energy transmitted is defined by the solar factor, g, which is the ratio of the total energy transmitted through the glazed surface or the interior glazing to the incident solar energy. The lower the solar factor, g value, the better the protection against solar radiation.

JP H0812378 A [NISSAN MOTOR] Jan. 16, 1996 describes a functional “solar control” stack comprising a tungsten oxide layer arranged between two dielectric layers. The stack makes it possible to reduce the surface electrical resistance and to increase the transparency to radio waves relative to the stacks comprising a metallic functional layer, in particular based on silver.

JP 2010180449 A [SUMITOMO METAL MINING CO [JP]] Aug. 19, 2010 describes a layer based on tungsten oxide deposited by sputtering using a tungsten oxide target comprising chemical elements selected from hydrogen, alkali metals, alkaline earth metals and rare earth metals. The layer has a “solar control” function by virtue of its high absorption of near-infrared radiation.

EP 3686312 A1 [SUMITOMO METAL MINING CO [JP]] Jul. 29, 2020 describes a layer based on tungsten oxide doped with cesium, and a method for depositing such a layer by sputtering. The layer has a transparency to radio waves and a “solar control” function by virtue, in particular, of its high absorption of infrared radiation.

EP 847965 A1 [SAINT-GOBAIN GLASS [FR]] 06.17.1998 discloses an example with a tungsten oxide layer WO₃ in the third dielectric module of a stack with two layers of silver and compares this example with two other examples comprising, rather than the tungsten oxide layer WO₃, a zinc oxide layer ZnO or a tin oxide layer SnO₂. There is no doubt that these layers are all dielectric in nature due to the stable stoichiometry of the material they are made of; if the atomic proportion between the elements in a layer were to be changed, this would profoundly alter the nature and the role of the layer in the optical definition of the stack and this would profoundly alter the stack.

US 4782216 [WOODARD [US]] 11.01.1988 discloses two examples of stacks with two layers of silver, each with a layer of stoichiometric tungsten oxide, WO₃, in two dielectric modules.

### SUMMARY OF THE INVENTION

### Technical Problem

For certain applications, for example in the building and construction markets, it is desirable for the glazing incorporating a substrate carrying a functional stack to have a visible light transmission, TL, that is low in the order of 50% or 60%, or average in the order of 70%, or high in the order of 75%, in order to ensure comfortable natural illumination of interior spaces.

A functional stack is called a functional stack suitable for such applications when it meets a triple requirement: an appropriate light transmission, a low solar factor value and a high selectivity value. A functional stack is therefore suitable when it has a high selectivity value, s, defined as the ratio of the light transmission to the solar factor, and a low solar factor, for a given light transmission.

The prior art solutions consisting of using, in the functional stack, only infrared radiation absorbent layers as functional layers, are not suitable because they have too low a light transmission or too low selectivity, incompatible for example with applications on the residential market.

There is therefore a need for a functional stack suitable for “solar control” applications in a residential market, that is having a high selectivity and suitable overall energy performance levels, notably regarding the solar factor.

### Solution to the Technical Problem

According to a first aspect of the invention, a glass substrate is provided having a functional stack of thin layers on at least one of its faces, said functional stack comprising, starting from the substrate, at least two metallic functional layers, each preferably silver-based, each located between two dielectric modules of thin layers and forming a succession comprising a first dielectric module, a first metallic functional layer, a second dielectric module, a second metallic functional layer and a last dielectric module, and wherein at least one of the dielectric modules of thin layers comprises a tungsten oxide layer having a physical thickness of between 5 nm and 50 nm, and:
the tungsten oxide comprising at least one doping element selected from the chemical elements of group 1 according to the IUPAC nomenclature, or
the tungsten oxide being pure substoichiometric, WOx, with x preferably between 2.55 and 2.98.

Said stack may comprise only two metallic functional layers, preferably each silver-based or may comprise only three metallic functional layers, preferably each silver-based. Although a stack configuration with multiple metallic functional layers is more complex to design and more expensive than a stack configuration with a single metallic functional layer, these disadvantages are outweighed by the surprising effects achieved, in particular such high selectivity and such low solar factor.

Depending on the configuration:
said functional stack comprises a single tungsten oxide layer and said tungsten oxide layer is preferably located in said first dielectric module or in said last dielectric module; or
said functional stack comprises two tungsten oxide layers and said tungsten oxide layers are preferably located one in said first dielectric module and the other in said last dielectric module; or
said functional stack comprises as many tungsten oxide layers as dielectric modules and each dielectric module comprises one tungsten oxide layer.

Preferably, the tungsten oxide layer(s) is (are) not in contact with a metallic functional layer (that is, there is an interposition of at least one layer of a different material from the other two); this enables optical separation between the infrared-reflecting functions of the metallic functional layer on the one hand, and the tungsten oxide layer on the other.

The optical refractive index of the tungsten oxide layer(s) is preferably decreasing monotonically with the wavelength from a maximum value greater than 2.4 at 350 nm up to a minimum value between 600 nm and 900 nm so that the difference between the maximum value and the minimum value is greater than 0.8, preferably greater than 1.0, or even greater than 1.4.

The optical extinction coefficient of the tungsten oxide layer(s) is preferably less than 0.2 at 500 nm and less than 2.0 at 1200 nm.

The (at least one, or all) tungsten oxide layer(s) of the stack may be dopant-free.

The tungsten oxide layer(s) may be made of pure substoichiometric tungsten oxide, WOx, with x preferably between 2.55 and 2.98, or even between 2.55 and 2.95 or 2.6 and 2.95.

If several layers of tungsten oxide 120a, 160a, 200a are present in the stack, they may have the same composition or different compositions:
one layer may comprise at least one dopant selected from the chemical elements of group 1 according to the IUPAC nomenclature and another layer may be made of pure substoichiometric tungsten oxide, WOx, with x preferably between 2.55 and 2.98; or
several layers may comprise at least one dopant selected from the chemical elements of group 1, the dopants not being identical; or
several layers can be made of pure substoichiometric tungsten oxide, WOx, with different x values, preferably between 2.55 and 2.98.

The tungsten oxide layer(s) may comprise one doping element, or several doping elements, preferably in a proportion such that the molar ratio of said element to tungsten, or the sum of the molar ratios of each element to tungsten, is between 0.01 and 0.4, preferably between 0.01 and 0.2, or even between 0.01 and 0.1.

The tungsten oxide layer(s) preferably comprise(s) at least one doping element selected from hydrogen, lithium, sodium, potassium and cesium.

The tungsten oxide layer(s) preferably comprise(s) cesium as a doping element, and the molar ratio of cesium to tungsten is between 0.01 and 0.2, preferably between 0.01 and 0.1. Preferably, cesium is the sole doping element.

The physical thickness of the tungsten oxide layer(s) is (or are) preferably between 5 nm and 30 nm, preferably between 5 nm and 20 nm or between 9 nm and 25 nm, or even between 12 nm and 20 nm.

Said functional stack of layers preferably further comprises at least one blocking overlayer, preferably based on nickel and chromium alloy, located above and in contact with a metallic functional layer and/or a metallic blocking underlayer, preferably based on nickel and chromium alloy, located below and in contact with a metallic functional layer.

The functional stack of layers preferably further comprises an oxide-based contact layer of titanium oxide located above and in contact with the metallic functional layer furthest from the substrate, said oxide-based contact layer preferably having a physical thickness of at least 5.0 nm, notably between 5.0 and 35.0 nm.

The functional stack of layers preferably comprises a layer with a refractive index greater than 2.15 at 550 nm, said layer being included in the last dielectric module.

According to a second aspect of the invention, a glazing is provided comprising a transparent substrate according to the first aspect of the invention.

According to a third aspect of the invention, a method is provided for manufacturing a transparent substrate according to the first aspect of the invention.

### Advantages of the Invention

A first advantage of the invention is that it provides a suitable “solar control” functional stack, in particular for applications in building and construction markets. The functional stack satisfies the triple requirement of appropriate light transmission, a low solar factor value, and a high selectivity.

As examples, a transparent substrate provided with a functional stack in accordance with the first aspect of the invention may, compared to a conventional functional stack, have a solar factor value lower than at least 2%, or even at least 4%, and an equivalent light transmission, or even greater than at least 1%, or even at least 2%.

A selectivity of at least 1.9, or even at least 2.0, can be achieved with double glazing incorporating a stack according to the invention comprising only two metallic functional layers and at least one tungsten oxide-based layer.

A second advantage is that the tungsten oxide layer(s) has (have) no influence, at least very little, on the color of the stack with respect to a conventional functional stack. The color specifications are thus always respected when such a layer is inserted into an existing functional stack.

Another advantage of the invention is that the tungsten oxide layer(s) can be deposited by a magnetron cathode sputtering method notably using a tungsten oxide target. Since the functional stacks of thin layers are generally deposited by a magnetron sputtering method, the existing methods can be more readily adapted.

### BRIEF DESCRIPTION OF THE DRAWINGS

FIG. 1 is a schematic representation of a first embodiment of the first aspect of the invention;

FIG. 2 is a representation of the evolution of the optical extinction coefficient based on the wavelength W, in nanometers, of an example with a layer of cesium-doped tungsten oxide and an example with a layer of pure, substoichiometric tungsten oxide;

FIG. 3 is a representation of the evolution of the optical refractive index based on the wavelength W, in nanometers, of an example with a layer of cesium-doped tungsten oxide and an example with a layer of pure, substoichiometric tungsten oxide;

FIG. 4 is a schematic representation of a first embodiment of a glazing according to the second aspect of the invention;

FIG. 5 is a schematic representation of a second embodiment of a glazing according to the second aspect of the invention;

FIG. 6 is a graphical representation of selectivity based on the light transmission for a counter-example CE, an example E1 and an example E2;

FIG. 7 is a graphical representation of selectivity based on the light transmission for counter-example CE, example E13′, example E13′″ and example E1;

FIG. 8 is a graphical representation of selectivity based on light transmission for counter-example CE, example E13′, example E15′, example E16′ and example E1; and

FIG. 9 is a graphical representation of selectivity based on light transmission for counter-example CE, example E24′, example E25′, example E26′ and example E2.

### DETAILED DESCRIPTION OF EMBODIMENTS

The following definitions and conventions are used.

The term “above”, respectively “below”, describing the position of a layer or of an assembly of layers and defined in relation to the position of another layer or another assembly, means that said layer or said assembly of layers is closer to, respectively further from, the substrate. These two terms, “above” and “below”, do not mean that the layer or the assembly of layers which they describe and the other layer or the other assembly with respect to which they are defined are in contact. They do not exclude the presence of other intermediate layers between these two layers. The expression “in contact” is explicitly used to indicate that no other layer is positioned between them.

Without any fuller information or qualifier, the term “thickness” used for a layer corresponds to the physical, real or geometric thickness of said layer. It is expressed in nanometers.

The expression “dielectric module” denotes one or more layers in contact with one another forming an assembly of layers which is dielectric overall, that is to say that it does not have the functions of a functional metal layer. If the dielectric module comprises several layers, they may themselves be dielectric. The physical, real or geometric thickness, of a dielectric module of layers, corresponds to the sum of the physical, real or geometric thicknesses, of each of the layers which constitute it.

In the present description, the expressions “a layer of” or “a layer based on”, used to describe a material or a layer as to what it contains, are used equivalently. They mean that the mass fraction of the constituent that it comprises is at least 50%, in particular at least 70%, preferably at least 90%. In particular, the presence of minority or doping elements is not excluded.

The term “transparent” used to describe a substrate means that the substrate is preferably colorless, non-opaque and non-translucent in order to minimize the absorption of the light and thus retain a maximum light transmission in the visible electromagnetic spectrum.

The light transmission in the visible spectrum, TL, the solar factor, g, and the selectivity, s, the internal reflection, Rint, and the external reflection, Rext, in the visible spectrum are defined, measured and calculated in conformity with the standards EN 410, ISO 9050 and ISO 10292.

In accordance with the nomenclature of IUPAC, group 1 of the chemical elements comprises hydrogen and alkaline elements, that is, lithium, sodium, potassium, rubidium, cesium and francium.

The expressions “optical refraction index” and “optical extinction coefficient”, are understood as the optical refraction index, n, and optical extinction coefficient, k, as defined in the technical field, in particular according to the Forouhi & Bloomer described in the Forouhi & Bloomer, Handbook of Optical Constants of Solids II, Palik, E. D. (ed.), Academic Press, 1991, Chapter 7.

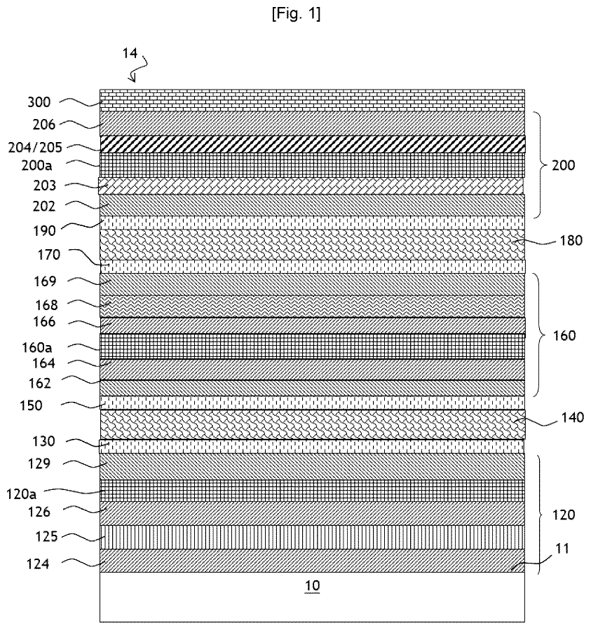

According to a first aspect of the invention, referring to FIG. 1, a transparent glass substrate 10 is provided equipped with a functional stack 14 of thin layers on at least one of its faces 11, said functional stack 14 comprising, starting from the substrate 10: at least two metallic functional layers 140, 180 each placed between two dielectric modules 120, 160, 200 of thin layers, and wherein at least one of the dielectric modules 120, 160, 200 of thin layers comprises a layer of tungsten oxide 120a, 160a, 200a, and:
either the tungsten oxide comprises at least one doping element selected from the chemical elements of group 1 according to the IUPAC nomenclature;
or the tungsten oxide of the tungsten oxide layer(s) 120a, 160a, 200a is a pure substoichiometric tungsten oxide, WOx, with x preferably between 2.55 and 2.98, or even between 2.55 and 2.95 or between 2.6 and 2.95; a value of x between 2.99 and 3.02 will be considered to give a pure stoichiometric tungsten oxide, WO₃.

This tungsten oxide layer 120a, 160a, 200a (and preferably each tungsten oxide layer 120a, 160a, 200a) has a physical thickness of between 5 nm and 50 nm: below 5 nm, the effect of such a layer on the optical definition of the stack is not sufficiently noticeable; it can be difficult, industrially, to deposit more than 50 nm of pure doped or substoichiometric tungsten oxide.

Surprisingly, a layer of tungsten oxide made of pure substoichiometric tungsten oxide, WOx, with a thickness of between 5 and 50 nm, has unexpected optical characteristics, notably in terms of the evolution of the optical extinction coefficient and of the refractive index based on the wavelength of the electromagnetic radiation. These characteristics combined with the presence of several metallic functional layers have a synergistic effect on the increase in selectivity.

Surprisingly, a layer of tungsten oxide comprising a doping element selected by the elements of group 1 according to the nomenclature of the IUPAC and a thickness of between 5 and 50 nm has unexpected optical characteristics, notably in terms of the evolution of the optical extinction coefficient and of the refractive index based on the wavelength of the electromagnetic radiation. These characteristics combined with the presence of several metallic functional layers have a synergistic effect on the increase in selectivity.

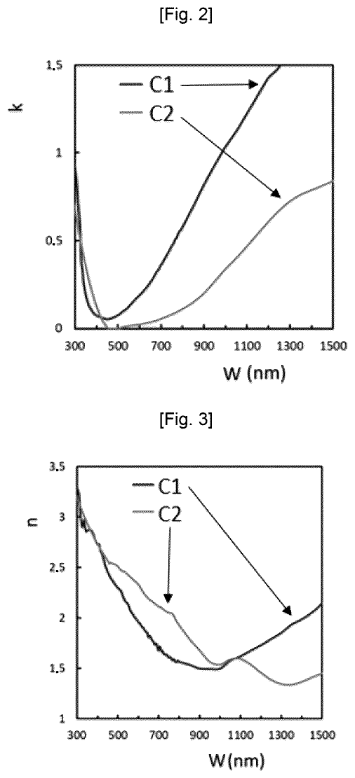

By way of illustrative and explanatory examples, to which, however, the present invention should not be considered inextricably linked, the evolution of the optical extinction coefficient, k, and the optical refractive index, n, are shown in FIG. 2 and FIG. 3 respectively, on the one hand for a layer C1 of cesium-doped tungsten oxide and on the other hand for a layer C2 of pure substoichiometric tungsten oxide, WOx, these layers being deposited by cathode sputtering on a soda-lime-silica glass substrate under two different deposition conditions.

On FIG. 2 and FIG. 3, layers C1 and C2 were deposited on a soda-lime-silica glass substrate on which a first layer based on silicon nitride was deposited beforehand with a thickness of around 5 nm. They were then covered with a second layer based on silicon nitride with a thickness of about 5 nm. In other words, each layer C1 and C2 is encapsulated between two layers based on silicon nitride.

The encapsulation of layers C1 and C2 by two layers based on silicon nitride has the function of preventing the degradation of layers C1 and C2 through excessive oxidation and/or excessive diffusion of oxygen in their structure. Instead of silicon nitride, it is possible to use any other type of suitable nitride such as, for example, zirconium nitride.

Layer C1 was deposited in an atmosphere comprising 20% dioxygen at a pressure of 4 mTorr. The stack thus obtained comprising layer C1 was annealed at 650° C. for 10 min after deposition. The molar ratio of cesium to tungsten is around 0.05-0.06.

Layer C2 was deposited on a tungsten metal target in an atmosphere comprising 60% dioxygen and at a pressure of 12 mTorr. The stack thus obtained comprising layer C2 was annealed at 650° C. for 10 min after deposition. Layer C2 is thus a layer of pure substoichiometric tungsten oxide, WOx, with an x of around 2.9.

The extinction coefficient and the refractive index were calculated by modeling from experimental measurements. The measurements were obtained using a Perkin Elmer Lambda 900 spectrophotometer and a VASE M-2000XI J. A. Wollam ellipsometer.

Referring to FIG. 2, regardless of layer C1 or C2, the extinction coefficient decreases monotonically from a value less than 1 at 300 nm to reach a minimum plateau less than 0.1 for C1 and less than 0.05 for C2 between around 400 nm and 550 nm, then increases monotonically to reach a value greater than 1.2 at around 1200 nm for C1 and a value greater than 0.5 at around 1200 nm for C2. Layers C1 and C2 have a strong absorption in the near infrared and a certain transparency in the visible range of the electromagnetic spectrum. Layer C2 has a lower absorption in the visible light spectrum and in the near infrared than layer C1.

Referring to FIG. 3, for layer C1, the optical refractive index decreases monotonically from a value close to 3 at 300 nm to reach a minimum plateau less than 1.8, or even 1.6 between around 800 nm and 1100 nm, then increases monotonically to reach a value greater than 1.8, or even 2 at around 1300-1400 nm. For layer C2, the optical refractive index decreases monotonically from a value close to 3 at 300 nm to reach a small plateau at a value close to 1.6 between around 900 nm and 1100 nm, then decreases monotonically again to reach a value of around 1.45 at around 1300 nm.

According to other preferred embodiments, the optical refractive index of the tungsten oxide layer 120a, 160a, 200a is decreasing monotonically with the wavelength from a maximum value greater than 2.4 at 350 nm up to a minimum value between 600 nm and 900 nm so that the difference between the maximum value and the minimum value is greater than 0.8, preferably greater than 1.0, or even greater than 1.4.

In other words, the value of the optical refractive index decreases monotonically by at least 0.8, preferably at least 1.0, or even at least 1.4 between a maximum value greater than 2.4 at 350 nm and a minimum value between 600 nm and 900 nm. As an example, the optical refractive index value can decrease monotonically by at least 0.8, preferably at least 1.0, or even at least 1.4 between a maximum value greater than 2.4 at 350 nm and a minimum value less than 2.3 between 600 nm and 900 nm, notably between 800 nm and 900 nm.

Without being particularly required to obtain the effects of the present invention, these optical refractive index values may nevertheless be advantageous as regards the color specifications for applications in building and construction markets. In particular, they make it possible to obtain neutral colors.

According to certain preferred complementary embodiments, the optical extinction coefficient of the tungsten oxide layer 120a, 160a, 200a may be less than 0.2, or even 0.1 at 500 nm and less than 2, or even 1.5 at 1200 nm. The selectivity can thus be advantageously further increased.

The optical extinction coefficient and the optical diffraction index can vary if one or several doping elements are included in the tungsten oxide layer and according to the nature and the amount of the doping element(s) selected from the elements of group 1 according to the IUPAC nomenclature. They may notably have different behaviors from what has been described previously in the context of the illustrative and explanatory examples of FIG. 2 and FIG. 3. However, it is currently difficult to establish a law of general behavior of the optical extinction coefficient and of the refractive index according to the nature and/or the amount of the doping element(s).

According to certain particular embodiments, the tungsten oxide layer comprises no doping elements and is made of pure substoichiometric tungsten oxide, WOx, with x preferably between 2.55 and 2.98 or between 2.55 and 2.95 or between 2.6 and 2.95.

According to certain particular embodiments, the tungsten oxide layer comprises the doping element X or the doping elements X1, X2, . . . in a proportion such that the molar ratio, X/W of said element to tungsten, W, or the sum of the molar ratios of each element to tungsten (X1+X2+ . . . )/W is between 0.01 and 0.4, preferably between 0.01 and 0.2, or even between 0.01 and 0.1. It was observed that these molar ratio values can advantageously make it possible to obtain the values of optical extinction coefficient and of refractive index described in the preceding embodiments while limiting the quantity of doping elements. Furthermore, a saving on the exploitation of the mineral resources for the doping elements may possibly result, as well as a reduction in costs.

According to certain embodiments, the tungsten oxide layer comprises at least one doping element selected from hydrogen, lithium, sodium, potassium and cesium. Among the elements of group 1, these particular elements can make it possible to obtain the most optimal values of optical extinction coefficient and refractive index for the desired technical effects.

According to particularly preferred embodiments, the tungsten oxide layer comprises cesium as a doping element, and the molar ratio of cesium to tungsten is between 0.01 and 0.2, preferably between 0.01 and 0.1. These embodiments make it possible to obtain the best performance as to the increase in selectivity, the preservation of neutral colors, and the cost savings.

What is most important in the context of the invention is that absorption in the visible range of the tungsten oxide layer(s) material is as low as possible in the visible range (wavelength 380 to 780 nm) to maximize the gain in selectivity.

The transparent substrate 10 may preferably be planar and may be of organic or inorganic, rigid or flexible nature. In particular, it may be a mineral glass, for example a soda-lime-silica glass.

Examples of organic substrates which can advantageously be used in the implementation of the invention may be polymer materials, such as polyethylenes, polyesters, polyacrylates, polycarbonates, polyurethanes or polyamides. These polymers can be fluoropolymers.

Examples of inorganic substrates which can advantageously be employed in the invention may be sheets of inorganic glass or glass-ceramic. The glass may preferably be a glass of soda-lime-silica, borosilicate, aluminosilicate or else alumino-borosilicate type. According to a preferred embodiment of the invention, the substrate 10 is a sheet of soda-lime-silica mineral glass.

The presence of the layer of tungsten oxide 120a, 160a, 200a in each dielectric module 120, 160, 200 allows the greater reductions in the solar factor and the most important increases in the light transmission.

According to certain advantageous embodiments, the physical thickness of the tungsten oxide layer(s) 120a, 160a, 200a can be between 2 nm and 50 nm, in particular between 5 nm and 30 nm, preferably between 5 nm and 20 nm. These intervals of thicknesses are sufficient to obtain the remarkable advantages of the first aspect of the invention.

FIG. 1 shows a structure of a stack 14 with several functional layers according to the invention deposited on one face 11 of a transparent glass substrate 10. This diagram shows the positions of different layers with respect to each other when these layers are present.

In this structure, the functional layers 140, 180, in particular, are based on silver or a silver-containing metal alloy, and are each arranged between two antireflective modules: the underlying antireflective module 120 located below the first functional layer 140 towards the substrate 10 and the intermediate antireflective module 160 arranged above the first functional layer 140 away from the substrate 10 and below the second functional layer 180. An overlying antireflective module 200 is arranged above the second functional layer 180 opposite the substrate 10.

These antireflective modules 120, 160, 200 each comprise at least one dielectric layer 124, 126, 129; 162, 164, 166, 168, 169; 202, 203, 204, 206.

A terminal protective layer 300, furthest from face 11, can complete the stack.

For the stack structure shown with two functional layers, the first functional layer 140 is located indirectly on the underlying antireflective module 120 and indirectly under the intermediate antireflective module 160: there is a blocking underlayer 130 located between the underlying antireflective module 120 and the first functional layer 140 and a blocking overlayer 150 located between the first functional layer 140 and the intermediate antireflective module 160.

For the stack structure shown with two functional layers, the second functional layer 180 is located indirectly on the underlying intermediate antireflective module 160 and indirectly under the antireflective module 200: there is an blocking underlayer 170 located between the underlying antireflective module 160 and the second functional layer 180 and a blocking overlayer 190 located between the second functional layer 180 and the antireflective module 200.

The function of each metallic functional layer 140, 180 is to reflect infrared radiation and/or part of the solar radiation. It may be any suitable metal, for example based on gold or based on silver. The thickness of each metallic functional layer 140, 180 may typically be between 2 nm and 25 nm, preferably between 10 nm and 20 nm.

According to preferred embodiments, each metallic functional layer 140, 180 is a silver-based layer.

The dielectric modules may comprise one or more layers with oxides and/or nitrides of metal and/or metal alloys, such as, for example, zinc oxide, mixed zinc tin oxide, silicon nitride, silicon oxide, zirconium nitride, titanium oxide, tin oxide, and silicon oxy-nitride.

The methods for depositing thin layers on substrates, in particular glass substrates, are methods well known in industry. By way of example, the deposition of a stack of thin layers on a glass substrate is carried out by successive depositions of each thin layer of said stack by passing the glass substrate through a succession of deposition cells suitable for depositing a given thin layer.

The deposition cells can use deposition methods such as magnetic field assisted sputtering, ion beam assisted deposition (IBAD), evaporation, chemical vapor deposition (CVD), plasma enhanced chemical vapor deposition (PECVD), low pressure chemical vapor deposition (LPCVD), etc.

The magnetic field enhanced sputtering deposition method is particularly used. The conditions for deposition of layers are widely documented in the literature, for example in patent applications WO2012/093238 A1 and WO2017/00602 A1.

A second aspect of the invention relates to a glazing, in particular single, double or triple glazing, comprising a transparent substrate according to any one of any of the described embodiments.

A monolithic glazing comprises a single substrate, in particular a mineral glass sheet. It may be a single glazing. When the substrate according to the invention is used as monolithic glazing, the functional stack of this layers is preferably deposited on the face of the substrate directed toward the interior of the room of the building on the walls of which the glazing is installed. In such a configuration, it can be advantageous to protect the first layer and optionally the stack of thin layers from physical or chemical damage using an appropriate means.

A multiple glazing comprises at least two substrates, in particular mineral glass sheets, that are parallel and separated by an insulating gas-filled cavity. The majority of multiple glazings are double or triple glazings, that is they respectively comprise two or three glazings. When the substrate according to the invention is used as element of a multiple glazing, the functional stack of thin layers is preferably deposited on the face of the glass sheet directed inward in contact with the insulating gas. This arrangement has the advantage of protecting the stack from chemical or physical damage from the external environment.

Such a stack of thin layers 14 can be used in a laminated glazing producing a separation between an exterior space and an interior space. This laminated glazing consists of two glass substrates which are held together by a plastic interlayer.

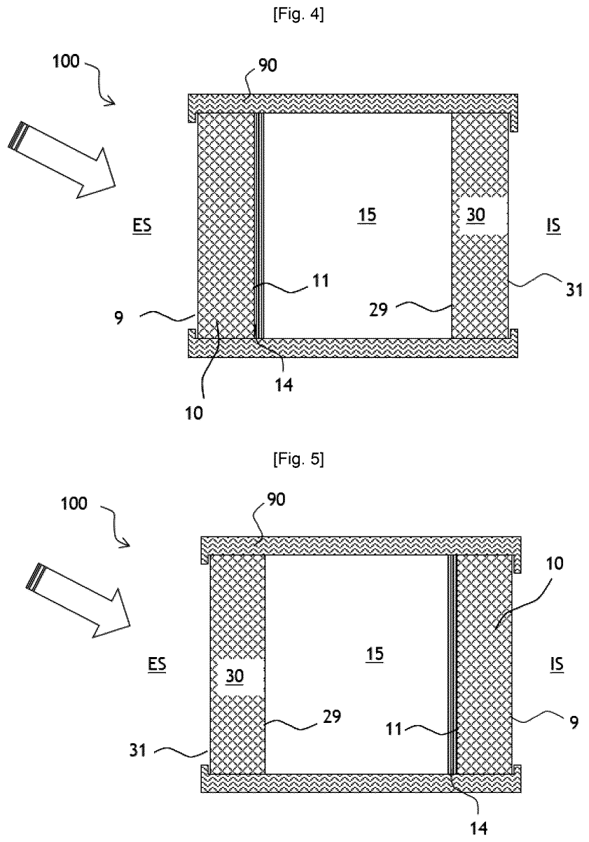

Such a stack of thin layers 14 can also be used in a multiple glazing 100 producing a separation between an exterior space ES and an interior space IS; this glazing can have a double-glazing structure, as shown in FIG. 4 or FIG. 5: this glazing then consists of two glass substrates 10, 30, which are held together by a frame structure 90 and which are separated from each other by an interlayer gas gap 15.

In [FIG. 4] and [FIG. 5], the incident direction of the sunlight entering the building is shown by the double arrow on the top or on the left.

According to a first embodiment, shown in FIG. 4, the stack 14 of thin layers is positioned on face 2 (on the sheet furthest towards the exterior of the building when considering the incident direction of sunlight entering the building and on the face thereof which is facing the gas gap), that is on an interior face 11 of the substrate 10 in contact with the interlayer gas gap 15, the other face 9 of the substrate 10 being in contact with the exterior space ES. The substrate 30, which does not carry a stack in FIG. 4, has one face 29 in contact with the interlayer gas gap 15, the other face 31 of the substrate 30 being in contact with the interior space IS; this substrate 30 may comprise a stack of thin layers on one of its faces or both of its faces.

According to a second embodiment, shown in FIG. 5, the stack 14 of thin layers is positioned on face 3 (on the sheet furthest towards the interior of the building when considering the incident direction of sunlight entering the building and on the face thereof which is facing the gas gap), that is on an interior face 11 of the substrate 10 in contact with the interlayer gas gap 15, the other face 9 of the substrate 10 being in contact with the interior space IS. The substrate 30, which does not carry a stack, has one face 29 in contact with the intermediate gas gap 15, the other face 31 of the substrate 30 being in contact with the exterior space ES.

Nevertheless, it may also be envisaged that, in this double glazing structure, one of the substrates has a laminated structure.

According to a third aspect of the invention, a method is provided for manufacturing a transparent substrate according to the first aspect of the invention, such that the tungsten oxide layer is deposited by a magnetron cathode sputtering method using a tungsten or tungsten oxide target, the material constituting said target optionally being doped using a chemical element selected from the chemical elements of group 1 according to the IUPAC nomenclature.

When a pure tungsten metal target or a pure tungsten oxide target is used, it can be used to deposit a layer of pure substoichiometric tungsten oxide, WOₓ, with x preferably between 2.55 and 2.98, or even between 2.55 and 2.95 or between 2.6 and 2.95.

One advantage of using a ceramic target (that is, with oxygen) over a metal target, particularly for rotating targets, is that the ceramic target is lighter, making it easier to control the method using this ceramic target.

When a ceramic or metallic target is used, it may in particular contain one or more doping elements in the proportions as described for the doped tungsten oxide layer in some embodiments of the first aspect of the invention.

The tungsten layer or layers can be deposited by cathode sputtering using the aforementioned target under an atmosphere comprising 0% to 50%, preferably 5% to 25% dioxygen under a pressure comprised between 1 and 15 m Torr, preferably 3 to 10 mTorr. Preferably, the deposition can be carried out cold, that is at a temperature of less than 100° C., notably between 20° C. and 60° C., for the substrate.

All the embodiments described, whether they relate to the first aspect or the second aspect of the invention, can be combined with one another without modification or particular adaptation. In the event that technical incompatibilities appear during the implementation of one of these combinations, it is within the scope of the person skilled in the art to be able to solve them by means of their knowledge without this requiring undue effort, in particular by implementing a research program.

### EXAMPLES

The features and advantages of the invention are shown by the examples and counter-examples described hereinafter.

In the following examples, the metallic functional layers 140, 180 are silver layers (Ag). The blocking layers 130, 150, 170, 190 are metallic layers made of nickel-chromium alloy (NiCr). The dielectric modules 120, 160, 200 comprise barrier layers, smoothing layers or wetting layers. The barrier layers are based on silicon nitride, doped with aluminum (Si₃N₄: Al), based on a silicon nitride and zirconium nitride. The smoothing layers are based on a mixed oxide of zinc and tin (SnZnOx). The wetting layers are made of zinc oxide (ZnO).

TABLE 1

| | | | Index |
|---|---|---|---|
| Name | Contents | Stoichiometry | (at 550 nm) |
| CWO | Cesium-doped tungsten | Cs/W = 0.05 | 2.20 for C1 |
| | oxide | | |
| WOx | Substoichiometric | WO_{2, 9} | 2.45 for C2 |
| | tungsten oxide | | |
| WO3 | Stoichiometric tungsten | WO₃ | 2.75 |
| | oxide | | |
| SiN | Aluminum-doped silicon | Si₃N₄:Al | 2.07 |
| | nitride | | |
| SiZrN17 | Silicon zirconium nitride | Si_{x′}Zr_{y′}N_{z′} with | 2.20 |
| | | y/(y + x) = 0.17 | |
| ZnO | Zinc oxide | ZnO | 2.00 |
| SnZnO | Zinc tin oxide | SnₑZn_{f}O | 2.00 |
| TiOx | Titanium oxide- | TiO₂ or similar | 2.20 |
| NiCr | Nickel-chromium alloy | Ni_{0.8}Cr_{0.2} | — |
| Ag | Ag | | — |

The conditions for deposition of the layers, which were deposited by sputtering (so-called “magnetron cathode” sputtering), are summarized in Table 2.

TABLE 2

| | | Deposition | | |
|---|---|---|---|---|
| Layer | Target used | pressure | | Gas |
| SiN | Si:Al at 92:8% | 3.2-6.10⁻³ | mbar | Ar/(Ar + N2) at 55% |
| | by weight | | | |
| SiZrN17 | Si:Zr:Al | 2.10⁻³ | mbar | Ar/(Ar + N₂) at 45% |
| | (78:17:5 at %) | | | |
| ZnO | Zn:Al at 98:2% | 1.8.10⁻³ | mbar | Ar/(Ar + O₂) at 63% |
| | by weight | | | |
| SnZnO | Zn:Sn (64:36 | 2.10⁻³ | mbar | Ar/(Ar + O₂) at 50% |
| | at %) | | | |
| WO3 | W | 2.10⁻³ | mbar | Ar/(Ar + O₂) at 20% |
| TiOx | TiO₂ | 2.10⁻³ | mbar | Ar/(Ar + O₂) at 95% |
| NiCr | Ni:Cr (80:20 | 2.3*10⁻³ | mbar | Ar at 100% |
| | at %) | | | |
| Ag | Ag | 8.10⁻³ | mbar | Ar at 100% |

at. = atomic

In the composition presentation tables of the following odd-numbered examples, the first two columns indicate the layer or module number, with reference to [FIG. 1], and the third column indicates the material for these layers. For these examples, the tables detail the complete contents of the stacks, starting from the surface 11 of a 6 mm-thick substrate 10, in the order shown (the materials and the physical thicknesses are in nanometers and the carrier substrate of the stack, made of clear glass, is in the last row, at the bottom of the tables). In the following, samples whose names begin with “CE” correspond to counter-examples; E1, E2, E13′, E13″, E24′, E24″, E′15, E16′, E25′, E26′ each correspond to a series of examples. In each series of examples or counter-examples, when the name ends with “a”, the aim is to achieve double-glazing light transmission of the order of 50%; when the name ends with “b”, the aim is to achieve double-glazing light transmission of the order of 60%; when the name ends with “c”, the aim is to achieve double-glazing light transmission of the order of 70%; when the name ends with “d”, the aim is to achieve double-glazing light transmission of the order of 75%. In each series of examples, when the name comprises a “1”, this means that layer C1 has been used and when the name comprises a “2”, this means that layer C2 has been used.

In order to achieve the low double-glazing light transmission of 50%, and in some cases to achieve the low double-glazing light transmission of 60%, a metal absorbent layer 125 is provided in the first dielectric module, between two nitride-based dielectric layers, as taught by international patent application No. WO 02/48065.

In a first series of examples E1a, E1b and E1c, the presence of the tungsten oxide layer C1 is tested in the first dielectric module 120 and the third dielectric module 200.

Counter-examples CEa, CEb, CEc do not comprise any tungsten oxide or tungsten oxide-based layers. Counter-examples CE′c and CE″c both comprise a dielectric layer 205 of stoichiometric tungsten oxide, WO₃, in the third dielectric module 200.

TABLE 3

| | | | CEa | E1a | CEb | E1b | CEc | E1c | CE′c | CE″c |
|---|---|---|---|---|---|---|---|---|---|---|
| | 300 | TiOx | 1 | 1 | 1 | 1 | 1 | 1 | 1 | 1 |
| 200 | 206 | SiN | 33 | 5 | 34 | 17 | 34 | 32 | 32 | 35 |
| | 200a | CWO | — | 27 | — | 12 | — | 5 | — | — |
| | 205 | WO3 | — | — | — | — | — | — | 2 | 5 |
| | 202 | ZnO | 5 | 5 | 5 | 5 | 5 | 5 | 5 | — |
| | 190 | NiCr | 0.7 | 0.7 | 0.7 | 0.7 | 0.7 | 0.7 | 0.7 | 0.7 |
| | 180 | Ag | 15.7 | 15.6 | 15.3 | 16.5 | 15.1 | 16.0 | 15.2 | 15.2 |
| | 170 | NiCr | 0.2 | 0.2 | — | — | — | — | — | — |
| 140 | 169 | ZnO | 5 | 5 | 5 | 5 | 5 | 5 | 5 | 5 |
| | 168 | SnZnO | 10 | 10 | 10 | 10 | 10 | 10 | 10 | 10 |
| | 164 | SiN | 65 | 75 | 67 | 73 | 66 | 71 | 66 | 66 |
| | 162 | ZnO | 5 | 5 | 5 | 5 | 5 | 5 | 5 | 5 |
| | 150 | NiCr | 0.7 | 0.7 | 0.7 | 0.7 | 0.7 | 0.7 | 0.7 | 0.7 |
| | 140 | Ag | 13.8 | 16.1 | 12.9 | 15.8 | 12.5 | 14.3 | 12.3 | 12.5 |
| | 130 | NiCr | 1 | 1 | 2.8 | 0.5 | 1.0 | — | 1.0 | 1.1 |
| 120 | 129 | ZnO | 5 | 5 | 5 | 5 | 5 | 5 | 5 | 5 |
| | 120a | CWO | — | 17 | — | 21 | — | 15 | — | — |
| | 126 | SiN | 18 | 6 | — | — | — | — | — | — |
| | 125 | NiCr | 2.2 | 0.5 | — | — | — | — | — | — |
| | 124 | SiN | 5 | 5 | 32 | 5 | 26 | 5 | 24 | 28 |
| 10 | | glass | | | | | | | | |

In the following tables presenting the properties of the even-numbered examples and counter-examples, the solar factor, g, the selectivity, s, the light transmission, TL, the light reflection on the internal face, Rint, and on the external face, Rext, as well as the color in transmission, in reflection on the internal face and in reflection on the external face, have been measured for each substrate of the examples and counter-examples assembled in a double glazed unit, as shown in FIG. 4. The second glass substrate 30 is a soda-lime-silica mineral glass with a thickness of 4 mm. The thickness of the interlayer air gap 15 composed of 90% argon is 16 mm. The stack 14 is arranged on face 2, or on face 11 of the substrate 10.

The expression “color”, used to describe a transparent substrate provided with a stack, is understood to mean the color as defined in the L*a*b* CIE 1976 chromatic space according to standard ISO 11664, in particular with a D65 illuminant and a visual field of 2° or 10° for the reference observer. It is measured in accordance with said standard. The measurements of the color parameters a* and b*, in transmission (a*T, b*T), in external reflection (a*Rext, b*Rext) and in internal reflection (a*Rint, b*Rint) are grouped together.

The light transmission in the visible spectrum, TL, the solar factor, g, and the selectivity, s, and the internal reflection, Rint, and the external reflection, Rext, in the visible spectrum are defined, measured and calculated in conformity with the standards EN 410, ISO 9050 and/or ISO 10292.

TABLE 4

| | CEa | E1a | CEb | E1b | CEc | E1c | CE′c | CE″c |
|---|---|---|---|---|---|---|---|---|
| TL | 49.0 | 49.0 | 59.0 | 59.4 | 69.0 | 69.0 | 69.9 | 69.0 |
| g | 26.0 | 23.6 | 31.6 | 29.0 | 37.7 | 35.9 | 37.8 | 37.7 |
| s | 1.881 | 2.073 | 1.866 | 2.047 | 1.828 | 1.924 | 1.826 | 1.829 |
| a*T | −6.9 | −8.8 | −5.8 | −7.2 | −4.1 | −5.4 | −4.1 | −4.2 |
| b*T | −2.2 | 0.0 | −2.4 | −1.5 | −0.3 | −1.2 | −0.3 | −0.9 |
| Rext | 18.0 | 17.4 | 16.7 | 16.5 | 15.0 | 14.5 | 15.0 | 15.0 |
| a*Rext | −1.1 | −1.0 | −1.0 | −2.1 | −1.0 | −1.0 | −1.3 | −1.5 |
| b*Rext | −4.2 | −10.0 | −6.5 | −7.7 | −7.8 | −5.8 | −8.1 | −6.6 |
| Rint | 20.6 | 21.7 | 16.4 | 18.4 | 14.4 | 15.2 | 14.3 | 14.4 |
| a*Rint | −0.4 | −6.0 | 0.0 | −6.1 | −0.9 | −2.1 | −1.0 | 0.0 |
| b*Rint | −5.0 | −4.8 | −5.0 | −5.0 | −5.0 | −5.0 | −5.0 | 4.8 |

Table 4 shows that the three examples E1a, E1b and E1c according to the invention have a light transmission TL similar to that, respectively of counter-examples CEa, CEb and CEc and a solar factor, g, better (lower) than those of counter-examples CEa, CEb and CEc. Counter-examples CE′c and CE″c have a light transmission TL, similar to that of example E1c and of counterexample CEc and a solar factor, g, similar to that of counterexample CEc and worse (higher) than that of example E1c.

Table 4 shows that the three examples E1a, E1b and E1c according to the invention provide a gain (increase) in selectivity, s, compared respectively with counter-examples CEa, CEb, CEc, CE′c and CE″c. This gain shows the synergistic effect of combining the tungsten oxide-based layer C1 with the first and the third dielectric module. A dielectric layer 205 of stoichiometric tungsten oxide, WO₃, in the third dielectric module 200 does not increase selectivity.

The exterior and interior reflections are further low; they are less than 22%.

In a second series of examples E2a, E2b, E2c and E2d of substrates according to the first aspect of the invention, the presence of the tungsten oxide layer C2 is tested in the first dielectric module 120 and in the third dielectric module 200. These examples are compared respectively with the same counter-examples CEa, CEb and CEc as previously and a counter-example CEd is added.

TABLE 5

| | | | CEa | E2a | CEb | E2b | CEc | E2c | CEd | E2d |
|---|---|---|---|---|---|---|---|---|---|---|
| | 300 | TiOx | 1 | 1 | 1 | 1 | 1 | 1 | 1 | 1 |
| 200 | 206 | SiN | 33 | 5 | 34 | 5 | 34 | 5 | 35 | 20 |
| | 200a | WOₓ | — | 18 | — | 16 | — | 21 | — | 9 |
| | 202 | ZnO | 5 | 5 | 5 | 5 | 5 | 5 | 5 | 5 |
| | 190 | NiCr | 0.7 | 0.7 | 0.7 | 0.7 | 0.7 | 0.7 | 0.7 | 0.7 |
| | 180 | Ag | 15.7 | 19.9 | 15.3 | 22.2 | 15.1 | 16.7 | 14.9 | 19.0 |
| | 170 | NiCr | 0.2 | 0.2 | — | 0.2 | — | — | — | — |
| 140 | 169 | ZnO | 5 | 5 | 5 | 5 | 5 | 5 | 5 | 5 |
| | 168 | SnZnO | 10 | 10 | 10 | 10 | 10 | 10 | 10 | 10 |
| | 164 | SiN | 65 | 68 | 67 | 72 | 66 | 72 | 67 | 75 |
| | 162 | ZnO | 5 | 5 | 5 | 5 | 5 | 5 | 5 | 5 |
| | 150 | NiCr | 0.7 | 0.7 | 0.7 | 0.7 | 0.7 | 0.7 | 0.7 | 0.7 |
| | 140 | Ag | 13.8 | 15.5 | 12.9 | 13.5 | 12.5 | 14.5 | 12.5 | 11.7 |
| | 130 | NiCr | 1 | 1 | 2.8 | 0.2 | 1.0 | 0.6 | — | — |
| 120 | 129 | ZnO | 5 | 5 | 5 | 5 | 5 | 5 | 5 | 5 |
| | 120a | WOₓ | — | 24 | — | 25 | — | 17 | | 23 |
| | 126 | SiN | 18 | 14 | — | 10 | — | — | — | — |
| | 125 | NiCr | 2.2 | 2.9 | — | 1.4 | — | — | — | — |
| | 124 | SiN | 5 | 5 | 32 | 5 | 26 | 5 | 20 | 6 |
| 10 | | glass | 6 mm | 6 mm | 6 mm | 6 mm | 6 mm | 6 mm | 6 mm | 6 mm |

Table 6 shows the properties of these examples and counter-examples.

TABLE 6

| | CEa | E2a | CEb | E2b | CEc | E2c | CEd | E2d |
|---|---|---|---|---|---|---|---|---|
| TL | 49.0 | 49.0 | 59.0 | 59.0 | 69.0 | 69.0 | 74.0 | 74.0 |
| g | 26.0 | 23.2 | 31.6 | 27.5 | 37.7 | 34.4 | 40.8 | 38.1 |
| s | 1.881 | 2.113 | 1.866 | 2.146 | 1.828 | 2.006 | 1.813 | 1.944 |
| a*T | −6.9 | −9.0 | −5.8 | −6.6 | −4.1 | −4.9 | −3.1 | −4.0 |
| b*T | −2.2 | −3.3 | −2.4 | 0.5 | −0.3 | −1.0 | 1.9 | 1.0 |
| Rext | 18.0 | 8.7 | 16.7 | 13.4 | 15.0 | 15.0 | 15.4 | 14.1 |
| a*Rext | −1.1 | −2.9 | −1.0 | −1.8 | −1.0 | −1.0 | −0.9 | −3.0 |
| b*Rext | −4.2 | 0.0 | −6.5 | 0.1 | −7.8 | −4.2 | −9.5 | −5.9 |
| Rint | 20.6 | 15.9 | 16.4 | 18.0 | 14.4 | 15.4 | 15.1 | 14.8 |
| a*Rint | −0.4 | −1.0 | 0.0 | 0.0 | −0.9 | −3.8 | −2.7 | −0.1 |
| b*Rint | −5.0 | −5.0 | −5.0 | −5.5 | −5.0 | −1.3 | −7.0 | −4.4 |

Table 6 shows that the four examples E2a, E2b, E2c and E2d according to the invention have a light transmission TL similar to that respectively of counter-examples CEa, CEb, CEc and CEd, and a solar factor, g, better (lower) than those of counter-examples CEa, CEb, CEc and CEd.

Table 6 shows that the four examples E2a, E2b, E2c and E2d according to the invention provide a gain (increase) in selectivity, s, compared respectively with counter-examples CEa, CEb, CEc and CEd. This gain shows the synergistic effect of combining the tungsten oxide-based layer C2 with the first and the third dielectric module.

The exterior and interior reflections are further low; they are less than 20%.

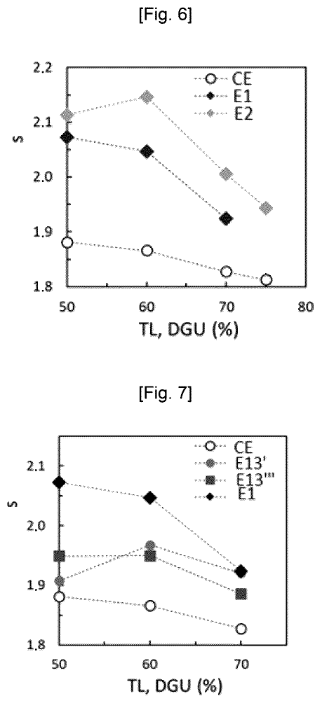

FIG. 6 summarizes the selectivities of examples E1a, E1b and E1c according to the invention, examples E2a, E2b, E2c and E2d according to the invention and counter-examples CEa, CEb, CEc and CEd and shows that the selectivity of the examples is always higher than that of the counter-examples for a similar light transmission.

In a third series of examples E13′a, E13″a, E13′b, E13″b, E13′c, and E13″c of substrate according to the first aspect of the invention, the presence of the tungsten oxide layer C1 is tested in the first dielectric module 120 only for examples comprising “′” in their name and in the third dielectric module 200 only for examples comprising a “′″” in their name. These examples are compared respectively with the same counter-examples CEa, CEb and CEc as previously (for properties only).

TABLE 7

| | | | E13′a | E13″′a | E13′b | E13″′b | E13′c | E13″′c |
|---|---|---|---|---|---|---|---|---|
| | 300 | TiOx | 1 | 1 | 1 | 1 | 1 | 1 |
| 200 | 206 | SiN | 34 | 19 | 34 | 7 | 35 | 17 |
| | 200a | CWO | — | 14 | — | 20 | | 16 |
| | 202 | ZnO | 5 | 5 | 5 | 5 | 5 | 5 |
| | 190 | NiCr | 0.7 | 0.7 | 0.7 | 0.7 | 0.7 | 0.7 |
| | 180 | Ag | 16.2 | 16.4 | 16.4 | 13.8 | 16.0 | 14.5 |
| | 170 | NiCr | 0.2 | 0.2 | 0.2 | 0.2 | — | — |
| 140 | 169 | ZnO | 5 | 5 | 5 | 5 | 5 | 5 |
| | 168 | SnZnO | 10 | 10 | 10 | 10 | 10 | 10 |
| | 164 | SiN | 67 | 65 | 71 | 71 | 71 | 70 |
| | 162 | ZnO | 5 | 5 | 5 | 5 | 5 | 5 |
| | 150 | NiCr | 0.7 | 0.7 | 0.7 | 0.7 | 0.7 | 0.7 |
| | 140 | Ag | 14.8 | 12.9 | 15.3 | 14.6 | 14.6 | 13.5 |
| | 130 | NiCr | — | — | 0.9 | 0.9 | 0 | 0 |
| 120 | 129 | ZnO | 5 | 5 | 5 | 5 | 5 | 5 |
| | 120a | CWO | 9 | — | 22 | — | 16 | — |
| | 126 | SiN | 9 | 31 | — | — | — | — |
| | 125 | NiCr | 1.8 | 2.4 | — | — | — | — |
| | 124 | SiN | 5 | 5 | 5 | 31 | 10 | 25 |
| 10 | | glass | 6 mm | 6 mm | 6 mm | 6 mm | 6 mm | 6 mm |

Table 8 shows the properties of these examples and compares them with the preceding counter-examples.

TABLE 8

| | CEa | E13′a | E13″′a | CEb | E13′b | E13″′b | CEc | E13′c | E13″′c |
|---|---|---|---|---|---|---|---|---|---|
| TL | 49.0 | 49.4 | 49.1 | 59.0 | 60.0 | 60.0 | 69.0 | 69.0 | 69.0 |
| g | 26.0 | 25.9 | 25.2 | 31.6 | 30.5 | 30.8 | 37.7 | 35.9 | 36.6 |
| s | 1.881 | 1.908 | 1.950 | 1.866 | 1.968 | 1.950 | 1.828 | 1.921 | 1.886 |
| a*T | −6.9 | −7.5 | −9.0 | −5.8 | −6.7 | −6.3 | −4.1 | −5.2 | −4.8 |
| b*T | −2.2 | −3.1 | −3.0 | −2.4 | −3.0 | −1.5 | −0.3 | −1.3 | −0.5 |
| Rext | 18.0 | 18.0 | 10.6 | 16.7 | 16.5 | 16.8 | 15.0 | 15.0 | 14.6 |
| a*Rext | −1.1 | −1.0 | −3.0 | −1.0 | −1.0 | −0.3 | −1.0 | −1.1 | −1.0 |
| b*Rext | −4.2 | 0.0 | −7.6 | −6.5 | −1.1 | −11.5 | −7.8 | −4.2 | −10.0 |
| Rint | 20.6 | 20.5 | 16.0 | 16.4 | 18.1 | 19.0 | 14.4 | 15.7 | 16.3 |
| a*Rint | −0.4 | −0.7 | −6.0 | 0.0 | −1.5 | −7.5 | −0.9 | −1.6 | −5.2 |
| b*Rint | −5.0 | −5.1 | −5.0 | −5.0 | −6.2 | 0.8 | −5.0 | −5.0 | −0.2 |

Table 8 shows that the six examples E13′a, E13″a, E13′b, E13″b, E13′c, and E13′″c according to the invention have a light transmission TL similar to that of, respectively, the counter-examples CEa, CEb and CEc and a solar factor, g, better (lower) than those of the counter-examples CEa, CEb and CEc.

The exterior and interior reflections are further low; they are less than 22%.

The comparison of the properties of examples E13′a, E13″a, E13′b, E13′″b, E13′c and E13″c according to the invention with respectively based on the light transmission range, these examples E1a, E1b and E1c according to the invention shows that the effect of the tungsten oxide-based layer is greater (lower solar factor) or similar when the first and the third dielectric modules both comprise this tungsten oxide-based layer.

FIG. 7 summarizes the selectivities of examples E1a, E1b and E1c according to the invention, examples E13′a, E13′b and E13′c according to the invention, examples E13′″a, E13′″b and E13″c according to the invention and counter-examples CEa, CEb and CEc and shows that the selectivity of the examples is always higher than that of the counter-examples for similar light transmission, and that this selectivity is higher or similar (for 70% light transmission) when the first and the third dielectric modules each comprise a tungsten oxide-based layer.

In a fourth series of examples, two examples E24′c and E24″c of substrate according to the first aspect of the invention test the presence of the tungsten oxide layer C2 in the first dielectric module 120 for example E24′c and in the three dielectric modules 120, 160 and 200 for example E24″c. These examples are compared with the same example E2c as previously.

TABLE 9

| | | | E24′c | E2c | E24″c |
|---|---|---|---|---|---|
| | 300 | TiOx | 1 | 1 | 1 |
| 200 | 206 | SiN | 34 | 5 | 7 |
| | 200a | WOx | — | 21 | 19 |
| | 202 | ZnO | 5 | 5 | 5 |
| | 190 | NiCr | 0.7 | 0.7 | 0.7 |
| | 180 | Ag | 15.6 | 16.7 | 16.3 |
| | 170 | NiCr | — | — | — |
| 140 | 169 | ZnO | 5 | 5 | 5 |
| | 168 | SnZnO | 10 | 10 | 10 |
| | 166 | SiN | — | — | 22 |
| | 160a | WOx | — | — | 15 |
| | 164 | SiN | 70 | 72 | 29 |
| | 162 | ZnO | 5 | 5 | 5 |
| | 150 | NiCr | 0.7 | 0.7 | 0.7 |
| | 140 | Ag | 16.1 | 14.5 | 14.2 |
| | 130 | NiCr | 0.9 | 0.6 | 0.5 |
| 120 | 129 | ZnO | 5 | 5 | 5 |
| | 120a | WOx | 13 | 17 | 19 |
| | 124 | SiN | 10 | 5 | 5 |
| 10 | | glass | 6 mm | 6 mm | 6 mm |

Table 10 shows the properties of these examples and counter-examples.

TABLE 10

| | CEc | E24′c | E2c | E24″c |
|---|---|---|---|---|
| TL | 69.0 | 69.0 | 69.0 | 69.0 |
| g | 37.7 | 36.2 | 34.4 | 33.4 |
| s | 1.828 | 1.905 | 2.006 | 2.065 |
| a*T | −4.1 | −4.5 | −4.9 | −5.5 |
| b*T | −0.3 | −0.6 | −1.0 | −0.5 |
| Rext | 15.0 | 15.0 | 15.0 | 15.0 |
| a*Rext | −1.0 | −1.0 | −1.0 | −2.9 |
| b*Rext | −7.8 | −4.0 | −4.2 | −5.0 |
| Rint | 14.4 | 14.8 | 15.4 | 15.3 |
| a*Rint | −0.9 | −1.6 | −3.8 | −5.3 |
| b*Rint | −5.0 | −5.0 | −1.3 | −4.1 |

Table 10 shows that the three examples E24′c, E2c and E24″c according to the invention provide a gain (increase) in selectivity, s, compared respectively to the counter-example CEc without a tungsten oxide-based layer.

Table 10 shows that for a similar light transmission TL of the order of 70%, the solar factor, g, is better (lower) when each dielectric module comprises one (and only one) tungsten oxide-based layer (example E24″c). Selectivity is slightly higher (though in practice very similar), when a tungsten oxide-based layer is provided in the first and the last dielectric module (example E2c).

The comparison of the properties of examples E24″c and E24c according to the invention shows that the effect of the tungsten oxide-based layer is greater (lower solar factor) when the three dielectric modules all comprise a tungsten oxide-based layer with respect to a configuration wherein only the first dielectric module comprises a tungsten oxide-based layer.

The exterior and interior reflections are further low; they are less than 20%.

In a further series of examples E15′a, E16′a, E15′b, E16′b, E15′c, and E16′c of substrate according to the first aspect of the invention, the presence of the tungsten oxide layer C1 is tested in the first dielectric module 120 for all these examples with further:
for series E15′: a high refractive index dielectric layer based on nitride 204 in the third dielectric module 200; and
for series E16′: an oxide-based contact layer 203 in the third dielectric module 200. These examples are compared with the same examples E13′a, E13′b and E13′c as previously (for properties).

TABLE 11

| | | | E15′a | E16′a | E15′b | E16′b | E15′c | E16′c |
|---|---|---|---|---|---|---|---|---|
| | 300 | TiOx | 1 | 1 | 1 | 1 | 1 | 1 |
| | 206 | SiN | 6 | 5 | 5 | 5 | 5 | 10 |
| 200 | 204 | SiZr17N | 21 | — | 23 | — | 24 | — |
| | 200a | CWO | — | — | — | — | — | — |
| | 203 | TiOx | — | 24 | — | 24 | — | 20 |
| | 202 | ZnO | 5 | — | 5 | — | 5 | — |
| | 190 | NiCr | 0.7 | — | 0.7 | — | 0.7 | — |
| | 180 | Ag | 18.8 | 19.3 | 17.8 | 18.8 | 17.0 | 18.1 |
| | 170 | NiCr | 0.2 | 0.2 | — | — | — | — |
| 140 | 169 | ZnO | 5 | 5 | 5 | 5 | 5 | 5 |
| | 168 | SnZnO | 10 | 10 | 10 | 10 | 10 | 10 |
| | 164 | SiN | 69 | 69 | 71 | 71 | 71 | 71 |
| | 162 | ZnO | 5 | 5 | 5 | 5 | 5 | 5 |
| | 150 | NiCr | 0.7 | 0.7 | 0.7 | 0.7 | 0.7 | 0.7 |
| | 140 | Ag | 14.7 | 15.3 | 15.3 | 14.4 | 14.5 | 16.7 |
| | 130 | NiCr | 1.0 | 1.0 | 1.3 | 3.0 | — | — |
| 120 | 129 | ZnO | 5 | 5 | 5 | 5 | 5 | 5 |
| | 120a | CWO | 15 | 13 | 24 | 19 | 16 | 16 |
| | 126 | SiN | 9 | 31 | — | — | — | — |
| | 125 | NiCr | 1.8 | 1.7 | — | — | — | — |
| | 124 | SiN | 7 | 6 | 5 | 5 | 10 | 10 |
| 10 | | glass | 6 mm | 6 mm | 6 mm | 6 mm | 6 mm | 6 mm |

Table 12 shows the properties of these examples and compares them with the preceding counter-examples.

TABLE 12

| | E13′a | E15′a | E16′a | E13′b | E15′b | E16′b | E13′c | E15′c | E16′c |
|---|---|---|---|---|---|---|---|---|---|
| TL | 49.4 | 49.9 | 49.8 | 60.0 | 59.2 | 59.6 | 69.0 | 69.0 | 69.0 |
| g | 25.9 | 24.8 | 24.7 | 30.5 | 29.3 | 29.2 | 35.9 | 35.3 | 34.8 |
| s | 1.908 | 2.015 | 2.013 | 1.968 | 2.024 | 2.040 | 1.921 | 1.952 | 1.983 |
| a*T | −7.5 | −8.3 | −6.9 | −6.7 | −6.6 | −5.6 | −5.2 | −5.1 | −5.2 |
| b*T | −3.1 | −1.7 | −2.9 | −3.0 | −2.3 | −2.2 | −1.3 | −0.9 | −1.4 |
| Rext | 18.0 | 15.5 | 17.9 | 16.5 | 16.3 | 16.2 | 15.0 | 15.0 | 15.0 |
| a*Rext | −1.0 | −2.3 | −3.0 | −1.0 | −2.3 | −3.0 | −1.1 | −1.0 | −1.0 |
| b*Rext | 0.0 | 0.0 | 0.0 | −1.1 | −2.1 | −2.2 | −4.2 | −4.0 | −4.0 |
| Rint | 20.5 | 18.5 | 20.3 | 18.1 | 18.0 | 16.4 | 15.7 | 15.7 | 15.6 |
| a*Rint | −0.7 | −0.5 | −2.7 | −1.5 | −3.0 | −2.3 | −1.6 | −2.1 | −1.3 |
| b*Rint | −5.1 | −5.0 | −5.0 | −6.2 | −5.7 | −5.6 | −5.0 | −2.8 | −3.9 |

Table 12 shows that the six examples E15′a, E16′a, E15′b, E16′b, E15′c, and E16′c according to the invention have a light transmission TL similar to that of, respectively, the counter-examples CEa, CEb and CEc and a solar factor, g, better (lower) than those of the counter-examples CEa, CEb and CEc.

Table 12 shows that the six examples E15′a, E16′a, E15′b, E16′b, E15′c and E16′c according to the invention provide a gain (increase) in selectivity, s, with respect to examples E13′a, E13′b and E13′c respectively. This gain shows the synergistic effect of combining the tungsten oxide-based layer C1 in the first dielectric module with, in the third dielectric module: a high refractive index nitride-based dielectric layer 204 or an oxide-based contact layer 203.

The exterior and interior reflections are further low; they are less than 22%.

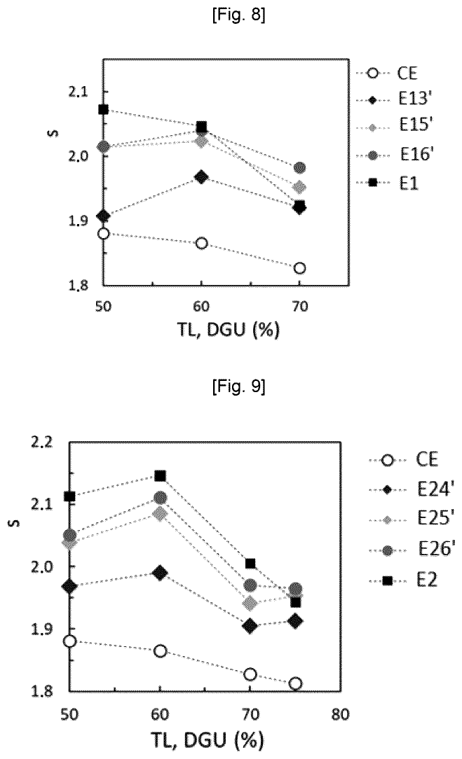

FIG. 8 summarizes the selectivities of examples E1a, E1b and E1c according to the invention, examples E13′a, E13′b and E13′c according to the invention, examples E15′a, E16′a, E15′b, E16′b, E15′c, and E16′c according to the invention and counter-examples CEa, CEb and CEc and shows that the selectivity of the examples is always higher than that of the counter-examples for similar light transmission and that this selectivity is higher or similar for the low light transmissions of 50% and 60% when the first and the third dielectric module each comprise a tungsten oxide-based layer. For average or high light transmission (70% or more), it may be preferable to provide a single tungsten oxide-based layer in the first dielectric module; a high refractive index nitride-based dielectric layer or an oxide-based contact layer in the third dielectric module can help achieve high selectivity.

Examples E25′a, E25′b and E25′c according to the invention and examples E26′a, E26′b and E26′c according to the invention have been produced in a similar way, one by one respectively to examples E15′a, E15′b, E15′c, E16′a, E16′b and E16′c according to the invention, replacing only layer C1 with layer C2; examples E25′d and E26′d have further been designed for double-glazing configurations having a light transmission of around 75%. Examples E24′a, E24′b and E24′d according to the invention have been produced in a similar way, one by one respectively to examples E2a, E2b and E2d according to the invention using a single layer C2, in the first dielectric module (that is without a layer in the third dielectric module), as for example E24′c presented above.

FIG. 9 summarizes the selectivities of examples E2a, E2b, E2c and E2d according to the invention, examples E24′a, E24′b, E24′c, and E24′d according to the invention, examples E25′a, E25′b, E25′c, and E25′d according to the invention, examples E26′a, E26′b, E26′c and E26′d according to the invention and counterexamples CEa, CEb, CEc and CEd. FIG. 9 shows that the selectivity of the examples is always higher than that of the counter-examples for similar light transmission. This FIG. 9 further shows that this selectivity is higher or similar when the first and the third dielectric module each comprise a tungsten oxide-based layer for the low light transmissions of 50% and 60% or for the average light transmission of 70%. For high light transmission (over 70%), it may be preferable to provide a single tungsten oxide-based layer in the first dielectric module; a high refractive index nitride-based dielectric layer or an oxide-based contact layer in the third dielectric module can help achieve high selectivity.

These examples very clearly show the advantages of the substrates of the invention, namely that they have a reduced solar factor, a higher selectivity, and have a neutral color, both for transmission as for reflections.

1. A glass substrate provided with a functional stack of thin layers on face thereof, said functional stack comprising, starting from the substrate, at least two metallic functional layers, each of the at least two metallic functional layers being located between two dielectric modules of thin layers and forming a succession comprising a first dielectric module, a first metallic functional layer, a second dielectric module, a second metallic functional layer and a last dielectric module, and wherein at least one of the first and second dielectric modules of thin layers comprises a tungsten oxide layer having a physical thickness of between 5 nm and 50 nm, and the tungsten oxide:
comprising at least one doping element selected from the chemical elements of group 1 according to the IUPAC nomenclature, or
being pure substoichiometric, WOx.

2. The glass substrate according to claim 1, wherein said functional stack comprises a single tungsten oxide layer.

3. The glass substrate according to claim 1, wherein said functional stack comprises two tungsten oxide layers.

4. The glass substrate according to claim 1, wherein said functional stack comprises as many tungsten oxide layers as dielectric modules and each dielectric module comprises a tungsten oxide layer.

5. The glass substrate according to claim 1, wherein the tungsten oxide layer is not in contact with a metallic functional layer.

6. The glass substrate according to claim 1, wherein an optical refractive index of the tungsten oxide layer is decreasing monotonically with a wavelength from a maximum value greater than 2.4 at 350 nm up to a minimum value between 600 nm and 900 nm so that a difference between a maximum value and a minimum value is greater than 0.8.

7. The glass substrate according to claim 1, wherein an optical extinction coefficient of the tungsten oxide layer is less than 0.2 at 500 nm and less than 2.0 at 1200 nm.

8. The glass substrate according to claim 1, wherein the tungsten oxide layer is pure substoichiometric tungsten oxide, WOx, with x between 2.55 and 2.95.

9. The glass substrate according to claim 1, wherein the tungsten oxide layer comprises a doping element, or several doping elements, in a proportion such that a molar ratio of said element to tungsten, or a sum of the molar ratios of each element to tungsten, is between 0.01 and 0.4.

10. The glass substrate according to claim 1, wherein the tungsten oxide layer comprises at least one doping element selected from hydrogen, lithium, sodium, potassium and cesium.

11. The glass substrate according to claim 10, wherein the tungsten oxide layer comprises cesium as a doping element, and a molar ratio of cesium to tungsten is between 0.01 and 0.2.

12. The glass substrate according to claim 1, wherein the physical thickness of the tungsten oxide layer is between 5 nm and 30 nm.

13. The glass substrate according to claim 1, wherein said functional stack of layers further comprises a blocking overlayer, located above and in contact with a metallic functional layer and/or at least one metallic blocking underlayer located below and in contact with a metallic functional layer.

14. The glass substrate according to claim 1, wherein the functional stack of layers further comprises an oxide-based contact layer, of titanium oxide, located above and in contact with the metallic functional layer furthest from the substrate.

15. The glass substrate according to claim 1, wherein the functional stack of layers comprises a layer with a refractive index greater than 2.15 at 550 nm, said layer being included in the last dielectric module.

16. A glazing comprising at least two transparent substrates, one of the at least two substrates being a substrate according to claim 1 arranged such that the functional stack of layers is located facing two and/or facing three of said glazing.

17. A method for manufacturing a transparent substrate according to claim 1, comprising depositing the tungsten oxide layer by a magnetron cathode sputtering method using a tungsten or tungsten oxide target, the material constituting said target being optionally doped using a chemical element selected from the chemical elements of group 1 according to the IUPAC nomenclature.

18. The glass substrate according to claim 1, wherein tungsten oxide is pure substoichiometric, WOx, with x between 2.55 and 2.98.

19. The glass substrate according to claim 1, wherein each of the at least two metallic functional layers is a silver layer.

20. The glass substrate according to claim 2, wherein said tungsten oxide layer is located in said first dielectric module or in said last dielectric module.
